(19) United States
(12) Patent Application Publication
(10) Pub. No.: US 2007/0256044 A1
(43) Pub. Date: Nov. 1, 2007

(54) SYSTEM AND METHOD TO POWER ROUTE HIERARCHICAL DESIGNS THAT EMPLOY MACRO REUSE

(76) Inventors: Gary Coryer, Colchester, VT (US); Dennis J. Hafer, Poughkeepsie, NY (US); Paul Hyrisk, Jericho, VT (US); Thomas M. Lepsic, Jeffersonville, VT (US)

Correspondence Address: GREENBLUM & BERNSTEIN, P.L.C., 1950 ROLAND CLARK DRIVE, RESTON, VA, 20191, US

(21) Appl. No.: 11/380,236

(22) Filed: Apr. 26, 2006

(51) Int. Cl. G06F 17/50

(52) U.S. Cl. 716/13; 716/14

(57) ABSTRACT

A method of routing a random logic macro (RLM) that is used multiple times in a hierarchical VLSI design without having to route each individual instantiation independently. Once an RLM has been routed and timed it can be copied and reused in a physical design as is, and does not require any wiring changes. This method is an advantage over existing art because it conserves area, improves wireability, and reduces the time required for routing and timing each RLM instance. Furthermore, each RLM possesses the same timing and power characteristics, which improves overall circuit performance.

### FIELD OF THE INVENTION

The invention relates to circuit fabrication, and more particularly to a system and method to power route hierarchical designs that employ macro reuse.

### BACKGROUND DESCRIPTION

The repetitive use of the same subset of logic is a technique that can improve the efficiency of the physical design process in terms of area and the effort required to layout a design. The biggest advantage of the repetitive use (re-use) of the same subset of logic offers the capability to have each copy of this logic implemented with identical placement, wiring and timing. This result can be achieved on “n” number of random logic macros (RLM) at the reduced expense of placing, routing and timing only one copy of the design. For example, using this approach, only one of each type of RLM needs to have the internal logic placed, routed and timed. Traditionally, though, the cost of RLM re-use is paid in additional area because of limitations in power routing these pseudo-regular structures.

By way of illustration, two main approaches have been historically employed to generate a grid to power these logic structures: (i) ring structures and (ii) on-grid wiring. In the ring approach, traditional power routing of macros employs ring structures that surround each object in the design. These ring structures typically consist of power and ground metal that completely surrounds the logic within the design, which thus ensures alignment with the grid regardless of pitch. Such techniques employ mandatory unused area adjacent to the ring structures, which are referred to as a “jog space” or “jog zone”. The jog space is necessary for chip-level power routing to stitch the core into the parent-level power grid, as well as to allow room for the power router at the parent-level to avoid collisions with power busses of opposite polarity that are internal to the macro. The ring structures and required space, however, do not scale with the size of the macro and thus, occupies a relatively larger area, as the macro becomes smaller.

In an example of the on-grid wiring approach, power patterns that are generated using a traditional top-down power routing do not recognize the logical similarities in underlying structures. For example, a m2 power route may cross instance1 of RLM “X” six channels from its left edge. However, a m2 power route may cross instance2 of the same RLM only five channels from the left edge. When a composite view of the m2 blockage for RLM “X” is generated, the net result is that channels five and six are blocked and therefore not available for signal wiring since only common non-blocked tracks can be used by the signal router. This problem occurs on each level of metal over the RLM where it is necessary to create both power and signal routes.

For a non-ringed design, the traditional approach is to place each instance of an RLM such that its relationship to each level of metal in the parents' power grid is identical to all other similar RLMs. To avoid excessive blockage creation in the composite blockage map, this rule must be followed for all instances. One way to facilitate this constraint is by making the x-dimensions and the y-dimensions a common multiple of the vertical and horizontal power patterns, respectively. This tends to force tradeoffs in terms of achieving maximum area utilization due to the relatively coarse nature of the power grid versus maintaining the flexibility to accommodate logic changes that grow the RLM.

For completeness, an alternative to forcing the RLM dimensions to be multiples of the power patterns is to separate the RLMs far enough apart to allow placement on similar parent-level power patterns. This approach avoids dissimilar blockage patterns from being created for each instantiation. Although this approach would enable parent-level dust logic placement between non-abutting RLM's, the practice has been to not use this disjoint and often isolated area for other logic placement.

### SUMMARY OF THE INVENTION

In a first aspect of the invention, a method comprises routing a power pattern from a reusable macro of a lower level upwards towards an upper level, n+1. The method further comprises extending the power pattern to a power structure on the upper level, n+1. The power structure may be at least a power grid. The method further comprises copying the power pattern for similar reusable macros of the reusable macro, thereby eliminating a need to route each individual instantiation of the similar reusable macros independently.

In another aspect of the invention, the method comprises providing a first macro and design layout and power routing the first macro. The method further comprises inserting a power structure at an upper level of the design and extending the routing of the first macro to the power structure.

In another aspect of the invention, a computer program product comprising a computer usable medium having readable program code embodied in the medium is provided. The computer program product includes at least one component to:

provide a design layout;

route a power pattern from a reusable macro of a lower level upwards towards an upper level, n+1, of the design layout;

extend the power pattern to a power structure on the upper level, n+1, the power structure including at least a power grid; and

copy the power pattern for similar reusable macros of the reusable macro, thereby eliminating a need to route each individual instantiation of the similar reusable macros independently.

### BRIEF DESCRIPTION OF THE DRAWINGS

FIG. 1 shows a hierarchical design in accordance with the invention;

FIG. 2 shows a physical implementation of a sample design in accordance with the invention;

FIG. 3 shows steps in accordance with the invention;

FIG. 4 shows a layout at a higher level of the design in accordance with the invention;

FIG. 5 shows a ring or partial ring structure in accordance with the invention;

FIG. 6 shows a result of extending power routes in accordance with the invention;

FIG. 7 shows a close-up of a region around “F1” which occurs by implementing the invention;

FIG. 8 schematically shows the result of extending power routes around a hard core (hard macro) to an upper level, n+1, in accordance with the invention;

FIG. 9 shows back filling of white space in accordance with the invention;

FIG. 10 shows a power routed core with hard objects that contain internal power routes which cannot be routed through, in accordance with the invention; and

FIG. 11 shows an illustrative environment for managing the processes in accordance with the invention.

### DETAILED DESCRIPTION OF EMBODIMENTS OF THE INVENTION

The invention relates to method of fabricating a circuit, and more particularly to a system and method to power route hierarchical designs that employ macro reuse. By using the method of the invention, routing of random logic macros (RLM) that are used multiple times in a hierarchical VLSI (very large scale integration) design can be achieved without having to route each individual instantiation independently. In embodiments of the invention, once an RLM has been routed and timed it can be copied and reused in a physical design, as is, and does not require any wiring changes. The method of the invention conserves valuable area, improves wireability, and reduces the time required for routing and timing each RLM instance. In this manner, the invention provides improved constraint resolution. Furthermore, by implementing the invention, each RLM possesses the same timing and power characteristics, which improves overall circuit performance.

As discussed in further detail below, a detailed signal routing within each repeated RLM must be identical to all other RLMs of the same type (because of critical timing requirements). For this to happen, each instance of the same RLM must contain the same power routes (patterns) and other blockage information. Thus, in accordance with the invention, as discussed in more detail below, a single wiring solution is created that is used for all instances of the same RLM thus ensuring identical parasitic values and hence timing results. This single blockage map can be seen by a detailed signal router in order to fabricate the circuit.

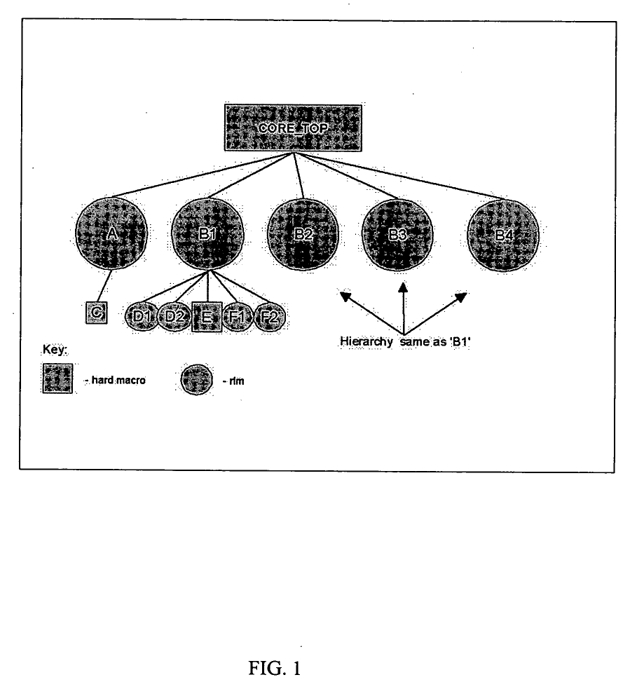

FIG. 1 shows a sample hierarchical design in accordance with the invention. As shown in the sample design of FIG. 1, the hierarchical design includes three levels with CORE_TOP being the top level of design. Logic blocks (RLM) “A” and “B” are on the first level, with logic block “B” having four instances, “B1”, “B2”, “B3” and “B4”. RLM “D” and “F” are repeated twice within logic block “B” (e.g., “D1”, “D2”, “F1” and “F2”). Thus, as should be understood, since logic block “B” is repeated four times and each logic block includes two instances of “D” and “F”, a total of eight placements of the RLM “D” and “F” are present in the entire exemplary design of FIG. 1. Hard macros (cores) “C” and “E” are found in the level one RLM “A” and “B”, respectively.

A hard macro refers to a macro that is already constructed and which cannot be manipulated. Accordingly the hard macro has logic constraint elements, which are fixed with respect to each other. In implementations, the invention will take into account these hard macros, to the extent that it can move them to appropriate locations which should not interfere with other wiring designs.

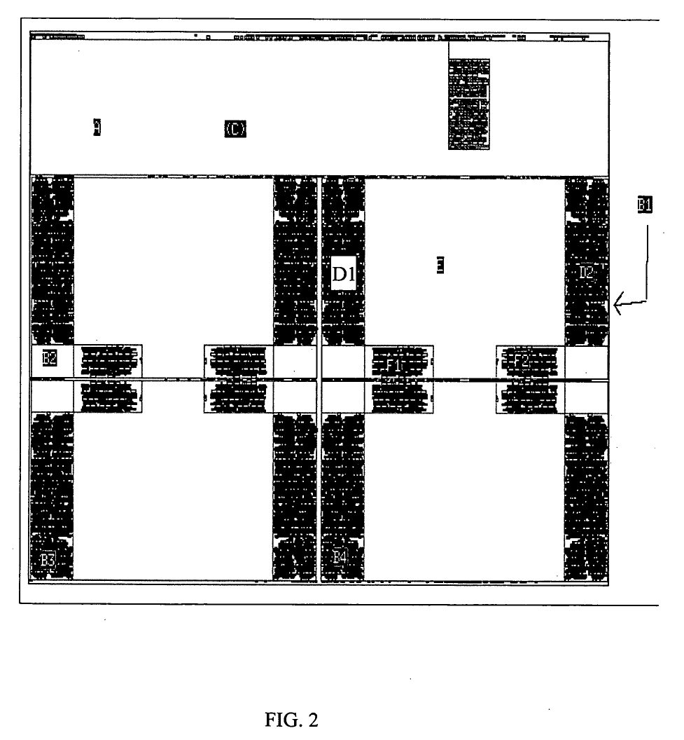

FIG. 2 illustrates a physical implementation of a sample design in accordance with the invention. In one illustrative example, this sample design corresponds to the logic blocks (RLMs) of FIG. 1. In this example, no power routes are shown. As shown in this exemplary illustration, the RLM “A” contains a hard macro “C” that is the same size as itself. RLM “A” also contains some random logic which can be seen on the right side of the macro, as illustrated. RLM “B1”, “B2”, “B3”, and “B4” are identical, all residing on the first level. RLM “D1”, “D2”, “F1” and “F2”, each reside on the second level and are found in each Bx-type RLM (e.g., “B1”, “B2”, “B3”, and “B4”). Hard macro “E” is also found in each Bx-type RLM.

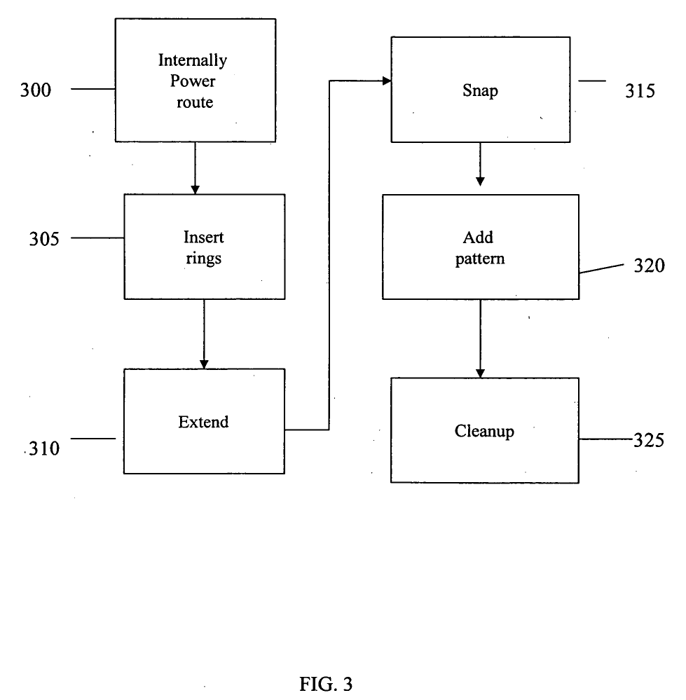

FIG. 3 is a flow diagram showing steps of the invention. It should be recognized, though, that FIG. 3 (and any other flows) is equally representative of a high-level block diagram implementing the steps of the invention. The steps of FIG. 3 may be implemented on computer program code in combination with the appropriate hardware, all well known to those of skill in the art. This computer program code may be stored on storage media such as a diskette, hard disk, CD-ROM, DVD-ROM or tape, as well as a memory storage device or collection of memory storage devices such as read-only memory (ROM) or random access memory (RAM). The steps of FIG. 3 are applicable for any level context. For example, this technique can be used for “n” level, with n+1 level being an upper level.

As described in more detail with reference to FIG. 3, in accordance with the invention, power routing preferably starts at the lowest level in the hierarchy where re-use occurs. Thus, in embodiments, the power routing will begin from the lowest level and be pushed upwards. However, it should be understood that, in some implementations, depending on a particular application, the power routing might start on any desired level. In the case of the example provided in FIGS. 1 and 2, the power routing begins at RLM “F1” (or “F2”, “D1”or “D2”).

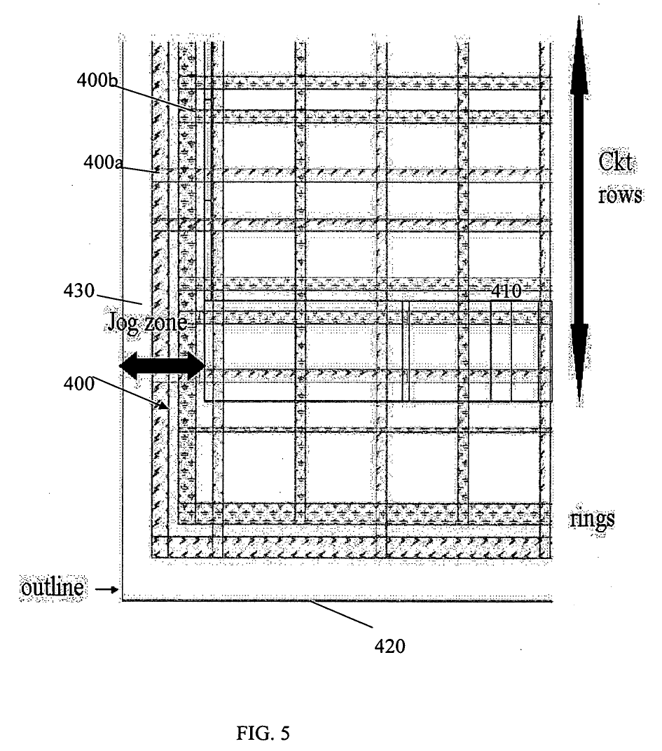

More specifically, at step 300, the system and method of the invention internally power routes each unique RLM, starting at a lower level, “n”. By way of example, shapes are generated with a standard power routing tool that follows wiring directives contained in a control file. (See, FIG. 3.) At step 305, a power ring structure is inserted at an upper or higher level, n+1. It should be understood that the power ring structure, using the example of FIG. 2, may be inserted at the top core level; although, the power ring structure or partial structure may be inserted at any higher level, n+1, depending on the particular implementation of the invention. It is also contemplated that the step 305 is optional. For example, instead of extending the routing to the ring structure, the power routing can be made directly to the power grid, in instances. Additionally, as an alternative embodiment, the power ring structure may be substituted with a partial ring structure or other structure that makes connection to the power grid. (See, FIG. 5.)

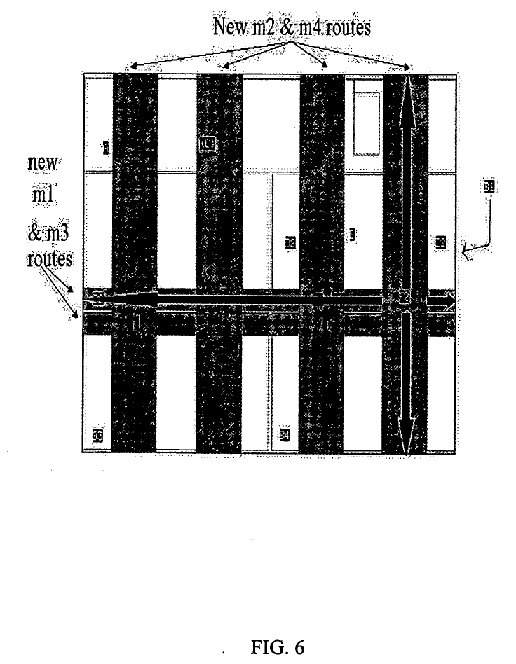

At step 310, the power routes of each of the RLMs are extended to an outline of the upper level design. That is, the power routes (patterns) within the RLMs are extended to the boundaries of the top-level object, n+1 (e.g., “CORE_TOP”). Thus, the power routes in each of these RLMs are propagated outward to form final top-level power routes. (See, FIG. 6.) At this stage, design constraints are provided at a lower level, n.

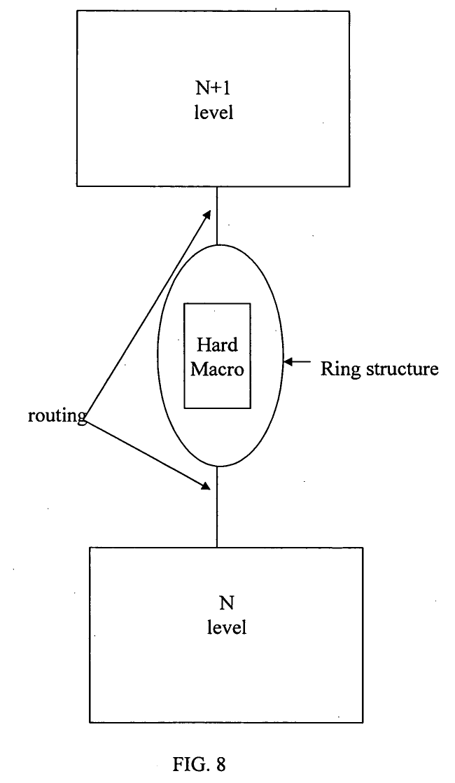

In embodiments, each hard (core) macro may also have a ring structure, partial ring structure or other power structure, in which case, the power routes for appropriate RLMs may be routed to the structure of the hard (core) macro and, thereafter, to a higher level object at level n+1. (See, FIG. 8.)

At step 315, the power routes are snapped back to terminate on the ring structure, partial ring structure or other structure, thus resulting in legalization. More specifically, this clean-up step retracts the end of the metal line (power route) to the ring structure, partial ring structure or other structure, leaving a jog space. Thus, in the example of using a power ring structure or partial power ring structure, this step preserves the jog space and eliminates any unnecessary extensions.

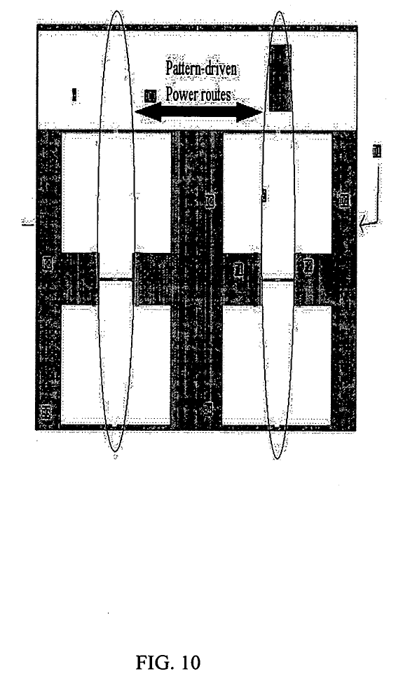

At step 320, a pattern is generated to back fill in any white space (see, FIG. 10) and, at step 325, a cleanup or legalization is performed. This may include a snap back of any routes. These steps are designed to uniformly distribute the power.

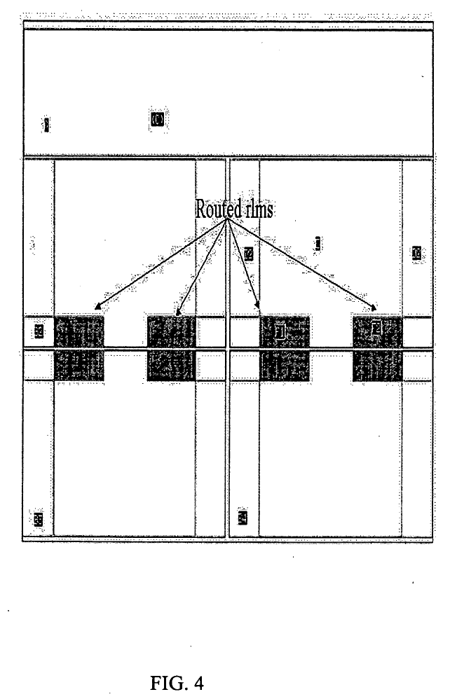

FIG. 4 shows an example of power routing a lower level, using the example of FIG. 2. In this example, eight power routed RLMs in the context of the root level of the design is shown. No other power routes are shown in the example; although in practice, RLM “D1” and “D2” (and all similar RLMs) would also be routed.

FIG. 5 shows a partial ring structure at level n+1, as discussed with reference to FIG. 3. This ring structure may equally be used for a hard macro. As seen in FIG. 5, the ring structure 400 includes a metal outer line 400a and a metal inner line 400b. In the example implementation, the outer line 400a is a voltage supply line and the inner line 400b is a ground line. In the case of a ring structure, the shape may take on many generic shapes such as a closed loop, a square or a rectangle, to name a few. Circuit functions are represented at reference numeral 410, located within the structure 400 comprising 400a and 400b. A jog space 430 exists between the circuit area 410 and the boundary line 420.

FIG. 6 shows the result of extending the power routes in the Fx RLMs, in accordance with the invention. As discussed with reference to FIG. 3, the power routes (patterns) within the RLMs are extended to the boundaries of the top-level object, at level n+1. In this illustrative example, the power routes in each of the RLMs are propagated outward to form upper level power routes. It should be understood by those of skill in the art that the power routes for each same or different function may be on different levels, as shown as “m1” and “m3”. In these instances, the power routes should all extend to the boundaries, in the east/west and north/south directions, which ever is applicable.

In embodiments, the shapes of FIG. 6 were generated with a standard power routing tool that followed wiring directives contained in a simple control file, which should be understood by those of skill in the art. Also, for illustration purposes only two orthogonal levels of metal are shown; however, the invention is equally valid for additional levels of metal.

In implementations, because of the RLM re-use employed in a specific design, these power routes will appear in all other similar RLMs. For example, using the illustrative and non-limiting example of FIG. 2, RLM “F2” in RLM “B1” will inherit the power routes (patterns) of RLM “F1” in RLM “B1”, as well as RLM “F1” and “F2” in RLM “B2”, “B3” and “B4”. Thus, by implementing the present invention, in this example, a total of eight RLMs can be power routed without the need to route each individual instantiation independently. This process is repeated for all other RLMs in the design that contain no children other than leaf cells.

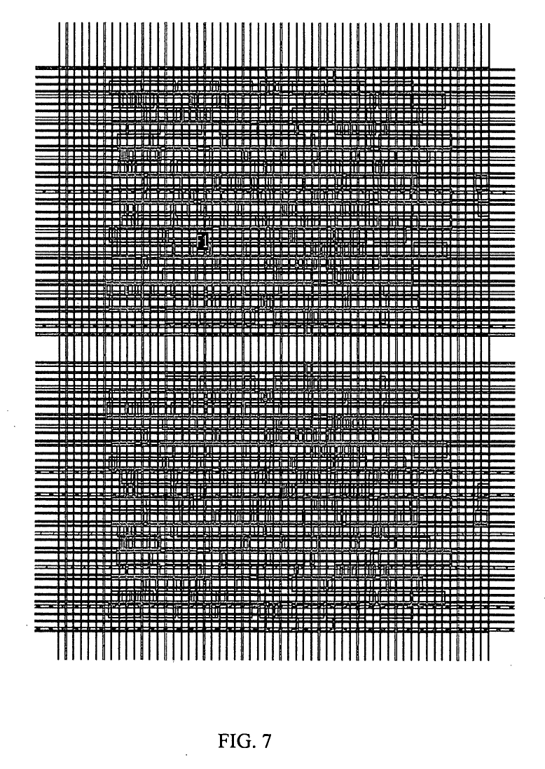

FIG. 7 shows a close-up of the region around “F1” in accordance with the invention. As a result of step 310 of FIG. 3, for example, power routes now connect adjacent cores (macros) and cover circuit rows that will be occupied by top-level logic. This process of growing the power patterns (routes) outward occurs for each child RLM to stitch them to one another as well as provide power routes for the top level of the design. The completeness of the parent-level power grid may be dependent on the number and placement of reused RLMs, but typically a cleanup step is now carried out, which may include, for example, inserting perimeter ring shapes at the top level to form a standard interface for parent/top level power routes and terminating internal feeder busses to these rings. In addition, in embodiments, top-level, pattern-driven power to areas are added between RLMs where no power routes exist which can be extended to created a top level power grid.

FIG. 8 schematically shows the result of extending the power routes around the hard core to an upper level, n+1. As shown in this representation, the power routing extends to an upper level, n+1, while extending to and around a ring structure, partial ring structure or other power structure of the hard core. In embodiments, the routing can extend to the ring of the hard core, without further extending to the upper level, n+1.

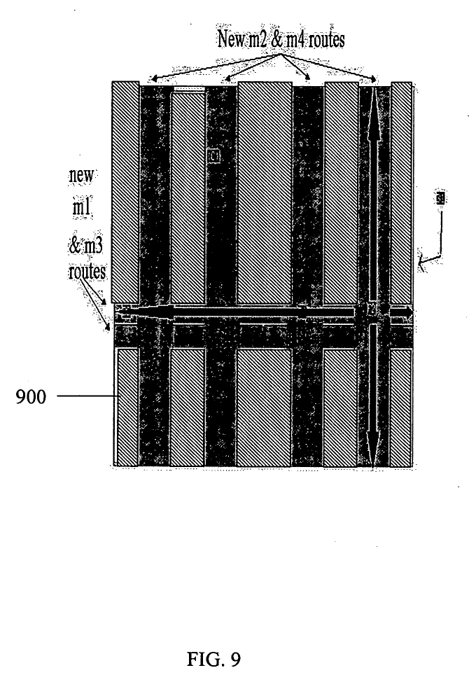

FIG. 9 shows back filling of white space in accordance with the invention. The backfill is shown as a cross hatched pattern, 900. The backfilling is designed to uniformly distribute power.

FIG. 10 shows a power routed core with hard objects (also known as macros or cores) that contain internal power routes which cannot be routed through. In FIG. 10, the areas over hard macros “C” and “E” have been depopulated of power shapes because of the presence of blockage. This is carried out by software tools that can detect and cut out power shapes that overlay blockage areas. The result is the compact physical implementation of a hierarchically-rich design.

The table below summarizes the reduction in area of the sample design that was realized through the use of the methodology of the present invention. As shown, there was a reduction of 8% realized with the present invention.

| | Traditional | New | |
|---|---|---|---|
| Area | (Ring'ed) | (Ringless) | Area |
| (millimeters²) | Methodology | Methodology | Change |
| Sample Design | 2.00 | 1.85 | −8% |

Thus, as should now be understood, the invention provides a methodology for power routing hierarchical designs that employ macro reuse and allows better area utilization than traditional techniques. The invention accomplishes this by eliminating the need for adding power rings to hierarchical objects within a design. For macros that are reused, this approach also eliminates the need to place all instances on multiples of the power pattern periodicities to prevent composite blockage from causing wiring congestion. That is, in embodiments, by implementing a bottom-up approach to power pattern routing, the invention is capable of providing a power route which avoids blockages from upper level patterns without manipulation of the power grid, e.g., without having to make the x-dimensions and the y-dimensions a common multiple of the vertical and horizontal power patterns, respectively. The approach of the invention could extend to densely populated chip-level designs that employ extensive hierarchy and logic reuse.

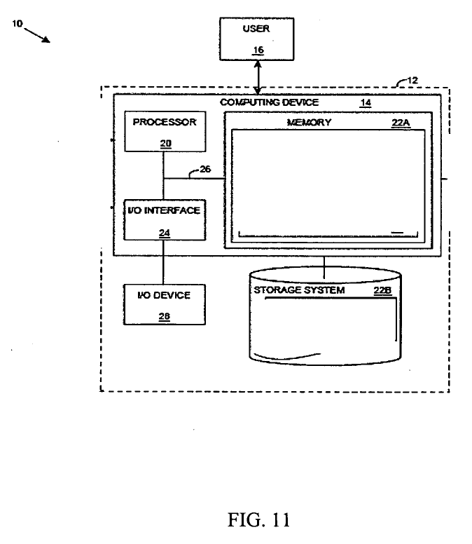

FIG. 11 shows an illustrative environment 10 for managing the processes in accordance with the invention. To this extent, the environment 10 includes a computer infrastructure 12 that can perform the processes described herein. In particular, the computer infrastructure 12 is shown including a computing device 14 operable to perform the processes described herein. The computing device 14 is shown including a processor 20, a memory 22A, an input/output (I/O) interface 24, and a bus 26. Further, the computing device 14 is shown in communication with an external I/O device/resource 28 and a storage system 22B. As is known in the art, in general, the processor 20 executes computer program code, which is stored in memory 22A and/or storage system 22B. While executing computer program code, the processor 20 can read and/or write data, such as the processes described herein, to/from memory 22A, storage system 22B, and/or I/O interface 24. The bus 26 provides a communications link between each of the components in the computing device 14. The I/O device 28 can comprise any device that enables an individual to interact with the computing device 14 or any device that enables the computing device 14 to communicate with one or more other computing devices using any type of communications link.

In any event, the computing device 14 can comprise any general purpose computing article of manufacture capable of executing computer program code installed thereon (e.g., a personal computer, server, handheld device, etc.). However, it is understood that the computing device 14 is only representative of various possible equivalent computing devices that may perform the processes described herein. To this extent, in other embodiments, the functionality provided by computing device 14 can be implemented by a computing article of manufacture that includes any combination of general and/or specific purpose hardware and/or computer program code. In each embodiment, the program code and hardware can be created using standard programming and engineering techniques, respectively.

Similarly, the computer infrastructure 12 is only illustrative of various types of computer infrastructures for implementing the invention. For example, in one embodiment, the computer infrastructure 12 comprises two or more computing devices (e.g., a server cluster) that communicate over any type of communications link, such as a network, a shared memory, or the like, to perform the process described herein. Further, while performing the process described herein, one or more computing devices in the computer infrastructure 12 can communicate with one or more other computing devices external to computer infrastructure 12 using any type of communications link. In either case, the communications link can comprise any combination of various types of wired and/or wireless links; comprise any combination of one or more types of networks (e.g., the Internet, a wide area network, a local area network, a virtual private network, etc.); and/or utilize any combination of various types of transmission techniques and protocols.

The method as described above is used in the fabrication of integrated circuit chips. The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

While the invention has been described in terms of exemplary embodiments, those skilled in the art will recognize that the invention can be practiced with modifications and in the spirit and scope of the appended claims.

What is claimed is:

1. A method, comprising:
routing a power pattern from a reusable macro of a lower level upwards towards an upper level, n+1;
extending the power pattern to a power structure on the upper level, n+1, the power structure including at least a power grid; and
copying the power pattern for similar reusable macros of the reusable macro, thereby eliminating a need to route each individual instantiation of the similar reusable macros independently.

2. The method of claim 1, wherein the reusable macro and the similar reusable macros are ringless macros and the routing is performed for a reusable macro that contains no children.

3. The method of claim 1, wherein the routing avoids blockages from upper level wiring routes without manipulation of the power grid.

4. The method of claim 1, further comprising generating shapes that follow wiring directives contained in a control file.

5. The method of claim 1, wherein the power structure includes at least one of a power ring and a partial power ring at the upper level, n+1, connecting to the power grid.

6. The method of claim 5, wherein the power structure surrounds a hard core macro at a level below the upper level, n+1.

7. The method of claim 5, wherein the power pattern of the reusable macro extends to an outline of a design on the upper level, n+1, and further comprises snapping back the power pattern to terminate on the power structure.

8. The method of claim 7, further comprising creating a jog space resulting from the snapping step.

9. The method of claim 1, further comprising generating a pattern to back fill white space.

10. The method of claim 9, wherein the power pattern is at least one of: on different levels and extends in different directions.

11. The method of claim 1, further comprising routing the power pattern to a hard core macro.

12. The method of claim 11, wherein the hard core macro is depopulated of power shapes.

13. The method of claim 1, wherein the steps of claim 1 are implemented on a computing infrastructure.

14. A method of physical design layout, comprising:
providing a first macro and design layout;
power routing the first macro;
inserting a power structure at an upper level of the design; and
moving the routing of the first macro to the power structure.

15. The method of claim 14, wherein:
the first macro is at a level, n, and the upper level is at a level, n+1;
the first macro is a reusable macro and similar macros to the first macro inherit a power pattern of the first macro, thereby eliminating a need to route each individual instantiation of the similar reusable macros independently;
the first macro is a reusable macro that contains no children; and
the first macro and the similar macros are ringless macros.

16. The method of claim 15, further comprising extending the first power route for the first macro to an outline of the power structure associated with the upper level and snapping back the first power route to terminate on the power structure.

17. The method of claim 16, wherein the power structure includes at least one of a power ring and a partial power ring connecting to a power grid.

18. The method of claim 16, further comprising creating a jog space resulting from the snapping step.

19. The method of claim 1, further comprising routing the first power route to a hard core macro.

20. A computer program product comprising a computer usable medium having readable program code embodied in the medium, the computer program product includes at least one component to:
provide a design layout;
route a power pattern from a reusable macro of a lower level upwards towards an upper level, n+1, of the design layout;
extend the power pattern to a power structure on the upper level, n+1, the power structure including at least a power grid; and
copy the power pattern for similar reusable macros of the reusable macro, thereby eliminating a need to route each individual instantiation of the similar reusable macros independently.
